(19) United States
(12) Patent Application Publication
(10) Pub. No.: US 2012/0072133 A1
(43) Pub. Date: Mar. 22, 2012

(54) Testing Apparatus and Method

(75) Inventors: John D. Norwood, Houston, TX (US); Jarod R. Hammar, Cypress, TX (US)

(73) Assignee: OFI TESTING EQUIPMENT, INC., Houston, TX (US)

(21) Appl. No.: 13/322,270

(22) PCT Filed: May 26, 2010
(86) PCT No.: PCT/US10/36216

§ 371 Date: Nov. 23, 2011

Related U.S. Application Data
(60) Provisional application No. 61/181,520, filed on May 27, 2009.

(51) Int. Cl. G06F 19/00; G01F 1/00; G01B 13/00; G01F 23/00

(52) U.S. Cl. 702/45; 702/55; 73/37.5

(57) ABSTRACT

In an exemplary embodiment of the present invention, a materials testing method and apparatus comprises a test cell, a temperature control system, a pressure control system, a volume measurement system, a strength indicator system, at least one processor and an output device. The apparatus provides real-time output of temperature and pressure conditions, volume change of a test sample, and strength indication. A method of sample testing includes concurrent measurement of pressure, temperature, volume measurement and strength indication. Processed data is output to at least one graphic user interface as a function of time.

### CROSS-REFERENCE TO RELATED APPLICATIONS

This application claims the benefit of U.S. Provisional Application No. 61/181,520 filed on May 27, 2009, which application is incorporated herein by reference as if reproduced in full below.

### STATEMENT REGARDING FEDERALLY SPONSORED RESEARCH OR DEVELOPMENT

Not applicable.

### BACKGROUND OF THE INVENTION

1. Field of the Invention

This invention relates generally to apparatus for measuring properties of materials, and more specifically to an apparatus for determining volume variation of a composition while measuring strength of the sample composition under determined temperature and pressure conditions.

2. Background

Oil drilling operations often require specifically formulated compositions. In the oil and gas industry, it is imperative to know and understand the material properties of compositions used during drilling and exploration and to determine how these properties are affected by temperature, pressure and time. For example, cement compositions may be cured under down-hole conditions of high pressure and temperature. Other materials and compositions are likewise subject to extraordinary conditions, including high temperature and pressure, and corrosive environments. Volume variation, hardness and uniformity of the composition are important properties to identify for such materials and compositions.

A conventional test cell for measuring cement expansion and shrinkage under high temperature and high pressure conditions comprises a canister structure having at least one removable end cap configured to allow input of a pressurizing fluid and having heating elements or at least partly immersed in a heating mechanism. A conventional measuring device for measuring expansion or contraction of cement is a linear variable differential transformer, LVDT. The LVDT system uses a magnetic core moveable within an array of electrical coils. Movement of the magnetic core produces electrical differential among coils. Measurement of such electrical differential is correlated with core movement to indicate core locations and relative movement of the magnetic core.

An expansion/shrinkage cell is disclosed in U.S. Pat. No. 6,918,292 issued to Boncan and Bray in 2005. This cell comprises essentially two vertical plates, having angled components to surround the sample, located intermediate two horizontal plates. The plates are connected using springs allowing expansion and contraction. Cement to be cured is put into the cell. The cell is exposed to the desired temperature and pressure conditions. Linear displacement transducers measure the expansion or shrinkage of the cement during the curing process.

U.S. Pat. No. 7,240,545 issued to Jennings in 2007 discloses a cement expansion and shrinkage cell that employs a piston rod for measurement. The cell has a cylindrical body having three main chambers. A lower chamber holds the curing cement and is separated from a middle chamber by a flexible diaphragm. The middle chamber holds pressurizing fluid and is separated from the upper chamber by a piston crown. The upper chamber holds pressuring fluid, the pressure of which may be adjusted. The piston crown is connected to a piston rod, which extends above the upper chamber. When the cement expands or contracts the piston rod moves. The piston rod is connected to a magnetic core. The movement of the magnetic core is measured using an appropriate measuring device. The disclosure suggests other means to measure rod displacement, such as a precision device or an optical scanner.

A conventional ultrasound tester for non-destructive testing of cement and other materials comprises an electromagnetic acoustic transducer for generating ultrasonic electromagnetic waves, a receiver for receiving reflected waves.

U.S. Pat. No. 7,587,943 issued to Wiggenhauser, et al. discloses a device for non-destructive testing of concrete components with ultrasound, comprising a sensor module with testing heads functioning as transmitter and/or receivers.

U.S. Pat. No. 5,628,319 to Koch, et al. discloses a method and device for non-destructive testing using ultrasonic pulses, an ultrasonic test head, conversion of received waves to electrical signals and amplification.

### BRIEF SUMMARY OF THE INVENTION

In an exemplary embodiment of the present invention, a materials testing method and apparatus comprises a test cell, a temperature control system, a pressure control system, a volume measurement system, a strength indicator system, at least one processor and an output device. The apparatus provides real-time output of temperature and pressure conditions, volume change of a test sample, and strength indication. A method of sample testing includes concurrent measurement of pressure, temperature, volume measurement and strength indication. Processed data is output to at least one graphic user interface as a function of time.

### BRIEF DESCRIPTION OF THE DRAWINGS

An exemplary embodiment of the invention is set forth in the following description in conjunction with the accompanying drawings, in which:

FIG. 1 depicts a cross-sectional view of an embodiment of a testing apparatus of the present invention.

FIG. 2 shows an exemplary graphic output of the testing apparatus of the present invention.

FIG. 3 shows a schematic block diagram of a testing apparatus of the present invention.

FIG. 4 depicts a method of the present invention.

### DESCRIPTION OF EMBODIMENTS OF THE INVENTION

An exemplary embodiment and its advantages are best understood by referring to the drawings, like numerals being used for like and corresponding parts of the various drawings.

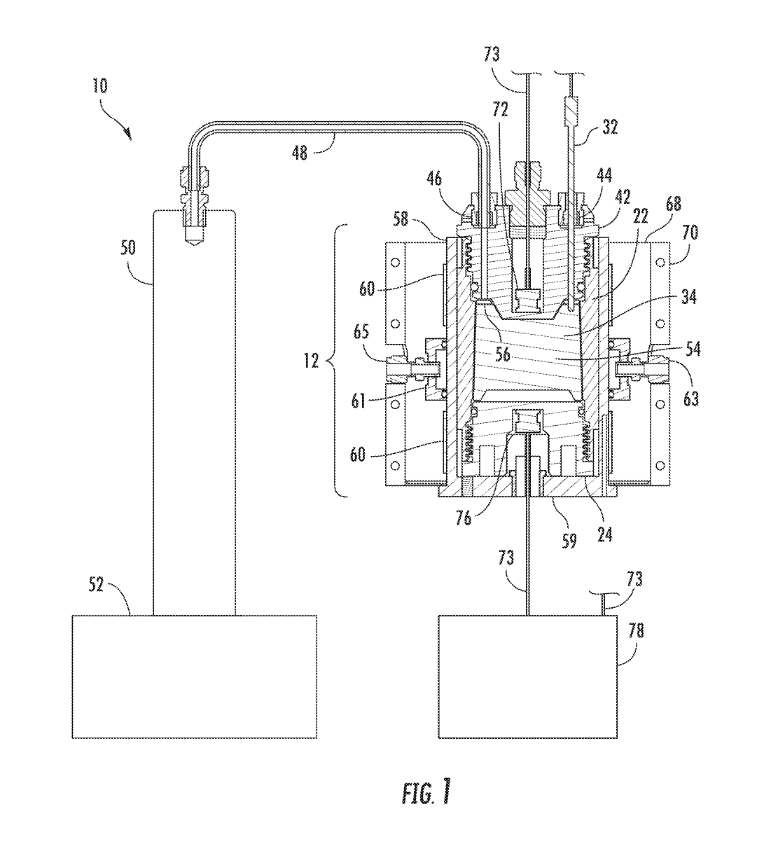

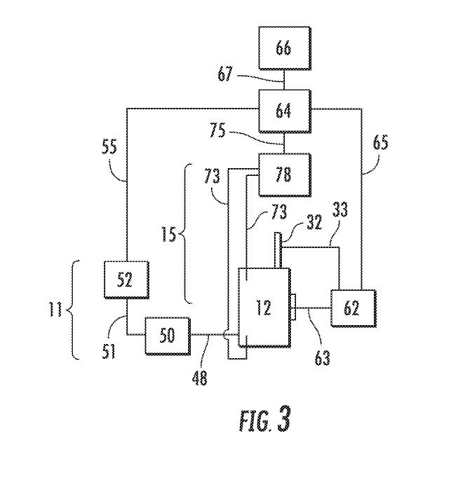

Referring to FIGS. 1 and 3, an exemplary embodiment of a material testing apparatus 10 is depicted. The apparatus 10 includes generally a test cell 12, a volume measurement system 11 including a bi-directional pump 50, a strength indicator system 15 including an ultrasonic transmitter 72 and receiver 76, a processor 64 and an output device 66.

Test cell 12 comprises a hollow cylindrical cell body 22, a lower cell base 24, and an upper cell cap 42. Cell base 24 is removably attached to cell body 22. Upper cell cap 42 is threadably connected to cell body 22. Cell body 22, cell base 24 and cell cap 42 define test cell interior 34. Test cell 12 is a vessel capable of being subjected to high temperature and high pressure.

A thermocouple port 44 is provided in cell cap 42. Port 44 is sized and structured to allow connection or insertion of thermocouple 32 to allow temperature measurement of cell interior 34.

A cylindrical jacket 58 surrounds cell body 22. Cylindrical jacket 58 has a bottom 59. Cylindrical jacket 58 is made of a thermally conductive material, such as aluminum. Cell body 22 fits slidably within cylindrical jacket 58. Heating elements 60 are attached to the external surface of cylindrical jacket 58. A cooling chamber 61 partially surrounds the cylindrical jacket 58. Cooling chamber 61 has an input port 63 and an output port 65. Cooling fluid may be passed through the cooling chamber to cool sample 54.

Thermocouple 32 is electronically connected to a temperature controller 62. Temperature controller 32 controls the temperature of cylindrical jacket 58 and consequently cell body 22 and a sample 54 contained in cell 12. Insulation 68 surrounds the cylindrical jacket 58, the heating elements 60, and the cooling chamber 61. An insulation jacket 70 retains the insulation in position.

While a temperature controller 32 may be structured to control cooling fluid flow in cooling chamber 61, flow of cooling fluid is often controlled manually.

A fluid port 46 is provided in cell cap 42. Port 46 is connected to fluid tube 48 and allows fluid communication between cell interior 34 and flow tube 48. Fluid tube 48 is connected to bi-directional pump 50 and allows fluid flow between cell interior 34 and pump 50.

Volume measurement system 11 includes a pump having flow metering capability, such as bi-directional pump 50, and pump controller 52. Bi-directional pump 50 is connected by fluid tube 48 to pump 50. Bi-directional pump is connected electronically to an associated pump controller 52. Such connection is represented by line 51 in FIG. 3. Pump 50 is operable in combination with controller 52 to provide pressure through fluid tube 48 at a determined level to test cell interior 34. Pump 50 can be operated to provide a constant pressure at test cell interior 34 at a level determined by an operator, or alternatively at various levels as required.

Strength indicator system 11 includes an ultrasonic transducer 72, an ultrasonic receiver 76 and a transducer controller 78. Ultrasonic receiver 76 is a transducer, but is referred to herein as a receiver for simplicity. Ultrasonic transducer 72 is provided in cell cap 42. Transducer 72 is operable to generate and transmit electromagnetic waves in the ultrasonic range. Receiver 76, which is also a transducer, is provided in cell base 24 for receiving ultrasonic signals from transducer 72. Transducer 72 and receiver 76 are electrically connected by communications cables 73 to an ultrasonic transducer controller 78.

Referring to FIG. 1, a sample 54 to be tested is depicted. Sample 54 is depicted for exemplary purposes and may comprise any material to be tested, including a cement composition.

A fluid 56 is depicted intermediate sample 54 and cell cap 42. Depending on the application, fluid 56 may be water, oil, or other appropriate non-compressible fluid.

In the exemplary embodiment depicted, sample 54 fills most of test cell interior 34. Fluid 56 is injected to fill the balance of interior 34.

Referring to FIG. 3, bi-directional pump 50 pumps fluid in discrete, accurately measurably increments. Pump 50 is electronically connected to pump controller 52. Pump controller 52 is operable to monitor fluid pressure at cell interior 34. In an exemplary embodiment such determination is made at a pressure transducer (not shown) provided in pump 50 proximate the outlet to flow tube 48. The pressure transducer is electronically connected to controller 52. A suitable pump 50 is described as a syringe pump manufactured by Teledyne Isco and marketed as Model D450. Other metering pumps with capability to accurately measure flow or combinations of pumps with meters to allow accurate flow measurement are acceptable.

Pump controller 52 is operable to receive and transmit data including pressure and flow into and from cell interior 34. Pump controller 52 is further operable to control flow into and from cell interior 34 and thereby control fluid pressure in cell interior 34. Pump controller 52 is operable to transmit pressure data and fluid flow data to processor 64 electronically as indicated by line 55 of FIG. 3.

Temperature controller 62 is electronically connected to thermocouple 32 as depicted by line 33 in FIG. 3. Temperature controller 62 is electronically connected to heating elements 60 as depicted by line 65 in FIG. 3. Temperature controller 62 is operable to control the temperature in cell interior 34. Temperature controller 62 is operable to electronically transmit data including temperature of cell interior 34 to processor 64 as indicated by line 65 in FIG. 3.

Transducer controller 78 is electronically connected to transducer 72 and receiver 76 (also a transducer) as indicated by communications cables 73 in FIG. 1. Transducer controller 78 is operable to control emission of electromagnetic waves from transducer 72 and to accumulate and process data received at receiver 76. Transducer controller 78 is operable to communicate data received, together with data resulting from processing of data received, to processor 64 as indicated by line 75 in FIG. 3.

Pump controller 52, temperature controller 62, and transducer controller 78 are operably connected to processor 64 through commercially available connections such as communications cabling with input-output connections.

Processor 64 includes a data processor operable to accumulate and process data accumulated by pump controller 52, temperature controller 62 and transducer controller 78 to provide determined information. For example, processor 64 can process data of fluid 56 flow through pump 50 and into or out of cell interior 34. Processor 64 can calculate volume variations of fluid 56 within cell interior 34, and consequently operable to calculate volume variations of sample 54. Such volume variations may be calculated and accumulated over time to produce output representing volume variations of sample 54 in cell 12 over time.

Processor 64 is operable to accumulate and process data from temperature controller 62 and to produce output representing temperature of sample 54 in cell 12 over time. In normal operation, the temperature of cell interior 34 is substantially the same as the temperature of sample 54.

Processor 64 is operable to accumulate and process data from transducer controller 78 and to produce output representing mechanical characteristics of sample 54 over time.

Processor 64 is operable to concurrently accumulate and process data from pump controller 52, temperature controller 62 and transducer controller 78 over time and to concurrently provide output of received data and/or processed data from all of pump controller 52, temperature controller 62 and transducer controller 78. Processor 64 is further operable to provide feedback and/or control signals to each of pump controller 52, temperature controller 62 and transducer controller 78 to adjust or maintain determined pressure or temperature conditions and to adjust or maintain transducer output or reception criteria.

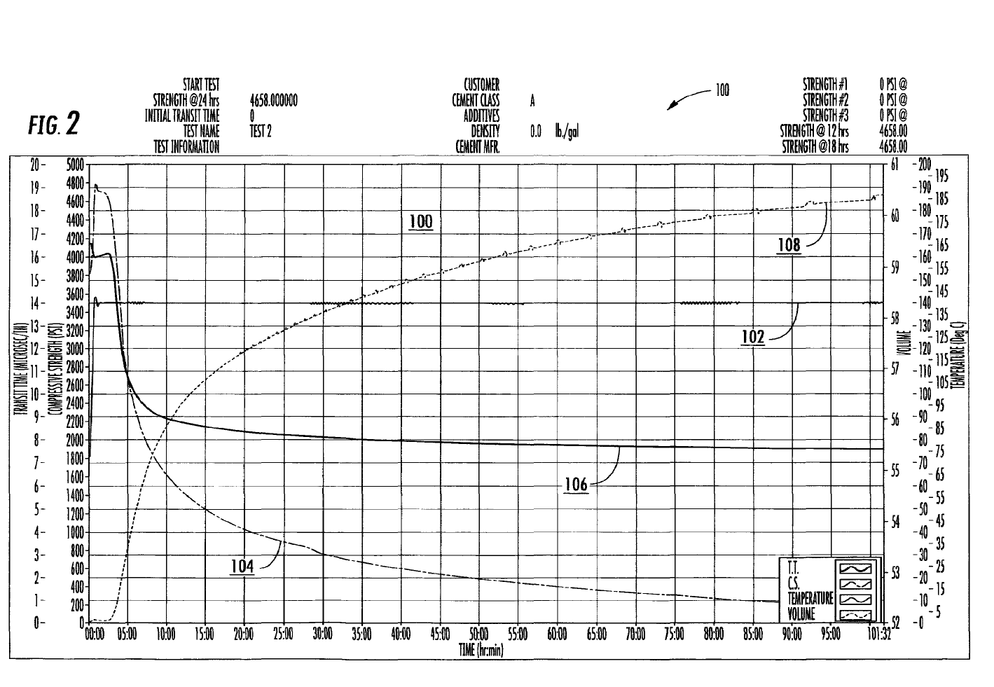

Processor 64 is electronically connected to an output device 66, to provide output representing volume, pressure, temperature, wave transit time, and correlated sample 54 strength variation over time. Such connection is represented at line 67 in FIG. 3. As depicted in FIG. 2, the output may be displayed as a graph 100 depicting data accumulated over time.

Referring to FIG. 2 a graphic user interface is displayed in graph 100. As indicated, line 102 of graph 100 provides accumulated and processed data representing temperature of cell interior 34 over time. Line 104 represents calculated volume variations of a sample 54 over time.

Still referring to FIG. 2 output from transducer controller 78 is depicted in graph 100 at line 106 and at line 108. Line 106 represents transit times of ultrasonic electromagnetic waves through sample 54. The transit time represents the time taken for electromagnetic waves to travel from transducer 72 to receiver 76. The strength of appropriate materials and compositions may be correlated to the transit time of an ultrasonic wave through a sample 54. Accordingly, the transit times are correlated to strength characteristics of the sample 54, typically by correlation to standards.

In the exemplary embodiment, transit time of various ultrasonic signals are identified by controller 78 with the accumulated data processed and transmitted to processor 64. Such transit time data is accumulated and used to calculate sample 54 strength parameters over time. Correlated strength is indicated at line 108 of FIG. 2.

As the testing apparatus 10 of the present invention is non-destructive and non-invasive, testing apparatus 10 may be practiced to concurrently determine volume variation of a sample 54 and strength of sample 54 while monitoring and controlling temperature and pressure conditions.

It is noted that ultrasonic electronic waves generated by transducer 72 are transmitted through sample 54. For purposes of this description, such waves are defined as non-invasive as they do not materially affect the composition of sample 54.

### Operation/Process

In an exemplary application, sample 54 comprises a cement composition mixed with water. The sample 54 is placed in cell 12 having a cell interior 34 of known volume. Cell base 24 and cell cap 42 are attached to cell body 22. Pump 50 is operated to insert a measured quantity of fluid 56 into cell interior 34.

Volume measurement system 11, including controller 52 operates pump 50 to maintain cell interior 34 at a constant, predetermined pressure. In the event of expansion of sample 54, pump 50 must pump fluid 56 out of cell interior 34 in order to maintain a determined pressure. The quantity of any such outflow is measured and the data accumulated by pump controller 52. In the event of contraction of sample 54, controller 52 operates pump 50 to pump fluid 56 into cell interior 34 in order to maintain a determined pressure. The quantity of any such inflow is measured and the data accumulated by pump controller.

Concurrently, temperature controller 62 receives temperature measurements of cell interior 34 from thermocouple 32. Temperature controller 62 is operable to control heating elements 60 to maintain a determined temperature of cell body 22. Temperature data is accumulated over time by temperature controller 62.

Concurrently, strength indicator system 15, including ultrasonic transducer 72 and ultrasonic receiver 76 are operable by ultrasonic controller 78 to determine strength characteristics of sample 54. Ultrasonic signals are generated and signal transit times through sample 54 are measured by controller 78. Transit time data is accumulated over time by controller 78.

Referring to FIG. 3, data from pump controller 52, temperature controller 62 and ultrasonic controller 78 are transmitted to common processor 64. Processor 64 produces an output in the form of a time graph 100 showing, in the exemplary application, sample 54 volume variations at line 104, sample 54 temperature at line 102, ultrasonic signal transit time through sample 54 at line 106, and correlated sample 54 strength (in this instance correlated compressive strength) at line 108.

Accordingly, concurrent tests, including volume variation of a sample are conducted with data output to a single graphic user interface.

### Method

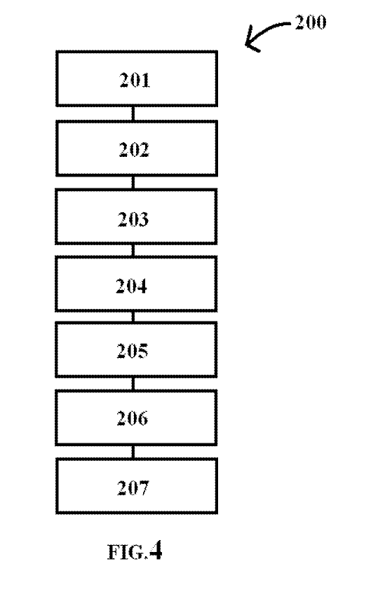

A method 200 of the present invention is outlined in FIG. 4.

A sample placement step 201 comprises placing a test sample 54 in a cell interior 34 of a test cell 12, said cell interior 34 having known dimensions.

A temperature control step 202 comprises maintaining sample 54 at a desired temperature. Step 202 further comprises measuring the temperature of the cell interior 34 and adjusting heat or cooling to the test cell 12 to maintain the desired temperature.

A pressure control step 203 comprises maintaining sample 54 at a desired pressure. Step 203 further comprises measuring the fluid pressure within cell interior 34 and adjusting fluid flow into and out of cell interior 34 to maintain the desired pressure.

A volume measurement step 204 comprises monitoring the quantities of fluid flowing into and out of the cell interior. Step 204 further comprises calculating the change in volume of the test sample 54 based on the quantities of fluid flow and the known dimensions of cell interior 34.

A strength indicator step 205 comprises monitoring the transit time of electromagnetic waves through sample 54. Step 205 further comprises transmitting electromagnetic waves from a transducer 72 through sample 54 to a receiver 76 located at a distal side of the sample 54, determining the transit time of the electromagnetic waves, and correlating the acquired transit times with strength data to determine an indicated strength of sample 54.

A processor step 206 comprises processing information obtained from steps 202, 203, 204 and 205 to provide output of data relating to the pressure and temperature conditions of a sample 54 while indicating a volume change measurement and indicated strength determination of sample 54.

An output step 207 comprises providing processed data to a user interface such as graph 100 on an output device 66.

In an exemplary embodiment, steps 202 through 207 are conducted regularly over time to produce real-time data relating to sample 54.

In an alternative embodiment, data acquisition, processing and control functions of pump controller 52, temperature controller 62, and ultrasonic controller 78 may be integrated, in whole or in part, into processor 64.

In an alternative exemplary embodiment, data output may be to other output devices such as printers or may be input to other processors.

In an alternative exemplary embodiment operable connections involving communications and electrical communications connections may be replaced by known communications media including “blue tooth” and other wireless connections. As used in this specification and the appended claims electronic connection and electronically connected means and includes transmission of data by known communications methods including communications cabling, buses, local area networks, communications networks, internet, satellite transmission, radio frequency transmission, blue tooth and other known data communications media.

In an alternative embodiment, one or more of pump controller 52, temperature controller 62, ultrasonic controller 78 and processor 64 may be combined into one or more integrated control and processing devices.

In an alternative embodiment, transducer 72 and receiver 76 may comprise a single transducer set with reflected and refracted electromagnetic waves received by the single transducer.

In an alternative embodiment, pressure of cell interior 34 may be alternately or additionally determined by a pressure meter, including a pressure transducer, attached to flow tube

Utilization of the apparatus 10 for volume measurement by volume measurement system 11 concurrently with strength indications of strength indicator system 15 is an exemplary use. The teachings of an exemplary embodiment are not intended to be limited to an application covering only use of the apparatus to provide concurrent volume measurement and strength indication.

Various embodiments of the invention will be understood from the foregoing description, and it will be apparent that, although embodiments of the invention have been described in detail, various changes, substitutions, and alterations may be made in the manner, procedure and/or details thereof without departing from the spirit and scope of the invention or sacrificing any of its material advantages, the forms hereinbefore described being merely exemplary embodiments thereof.

I claim:

1. An apparatus for measuring properties of a sample comprising:
a test cell;
said test cell having a cell interior;
a volume measurement system;
a strength indicator system;
at least one processor operationally connected to each of the volume system, the temperature system, the pressure system and the strength system; and
an output device.

2. The apparatus of claim 1 further comprising:
said volume measurement system including a pump and a pump controller;
said pump fluidly connected to the cell interior;
said pump operable to transmit fluid into and out of said cell interior; and
said pump operable to measure quantities of fluid flow into and out of said test cell;
said pump controller operable to receive and process fluid flow information; and
said pump controller electronically connected to said at least one processor.

3. The apparatus of claim 2 further comprising:
said strength indicator system comprising at least one transducer, at least one receiver and a transducer controller;
said at least one transducer proximate said test cell;
said at least one transducer operable to transmit a plurality of electromagnetic waves into said cell interior;
said at least one receiver operable to receive electromagnetic waves from said cell interior; and
said transducer controller operable to receive and process data from said at least one receiver.

4. The apparatus of claim 3 further comprising:
at least one processor;
said at least one processor electronically connected to said volume measurement system and to said transducer system assembly;
said at least one processor electronically connected to an output device; and
said volume measurement system, said transducer system and said processor concurrently operable.

5. The apparatus of claim 4 further comprising:
a temperature control assembly comprising a thermocouple, at least one heating element, a cooling chamber, and a temperature controller;
said temperature controller electronically connected to said thermocouple and said at least one heating element;
said temperature controller electronically connected to said at least processor; and
said temperature controller operable to transmit temperature data to said at least one processor.

6. The apparatus of claim 5 further comprising:
a pressure control assembly comprising at least one pressure measurement device, at least one heating element, at least one cooling chamber, and a pressure controller;
the pressure controller electronically connected to said at least one processor; and
said pressure controller operable to transmit pressure data to said at least one processor;

7. The apparatus of claim 6 further comprising:
said pump controller and said pressure controller comprising a single pump and pressure controller.

8. The apparatus of claim 3 further comprising:
said at least one receiver comprising a transducer.

9. The apparatus of claim 3 further comprising:
said at least one transducer and said at least one receiver oriented with respect to said test cell to allow placement of a sample intermediate said at least one transducer and said at least one receiver.

10. The apparatus of claim 3 further comprising:
said output device including a graphic display, said graphic display operable to provide values of sample temperature, volume and strength indication during selected time intervals.

11. A method for measuring properties of a test sample comprising:
a sample placement step;
a temperature control step;
a pressure control step;
a volume measurement step; and
a strength indicator step.

12. The method of claim 11 further comprising:
a processor step; and
an output step.

13. The method of claim 12 further comprising:
each of said temperature control step, said pressure control step, said volume measurement step and said strength indicator step conducted concurrently.

14. The method of claim 12 further comprising:
each of said temperature control step, said pressure control step, said volume measurement step, said strength indicator step, said processor step and said output step conducted concurrently.

15. The method of claim 14 further comprising:
said output step comprising providing process data to a graphic display, said graphic display providing values of sample temperature, volume and strength indication during selected time intervals.
